(19) United States
(12) Patent Application Publication
(10) Pub. No.: US 2013/0111340 A1
(43) Pub. Date: May 2, 2013

(54) APPARATUS AND METHOD FOR PROCESSING ELECTRONIC DOCUMENT

(71) Applicant: Jong-Kuk Lee, Daejeon-si (KR)

(72) Inventor: Jong-Kuk Lee, Daejeon-si (KR)

(73) Assignee: Electronics and Telecommunications Research Institute, Daejeon (KR)

(21) Appl. No.: 13/617,990

(22) Filed: Sep. 14, 2012

(30) Foreign Application Priority Data
Oct. 31, 2011 (KR) 10-2011-0112421

(51) Int. Cl. G06F 17/00

(52) U.S. Cl. 715/273

(57) ABSTRACT

An apparatus and method for processing an electronic document that provide an electronic document which is multi-hierarchically structured are provided. The apparatus stores the electronic document including a basic layer having a basic document and an additional layer having displayable additional information which is associated with the basic document, and configures a screen including the basic document and the additional information.

### CROSS-REFERENCE TO RELATED APPLICATION

This application claims the benefit under 35 U.S.C. §119(a) of Korean Patent Application No. 10-2011-0112421, filed on Oct. 31, 2011, the entire disclosure of which is incorporated herein by reference for all purposes.

### BACKGROUND

1. Field

The following description relates to technology for processing computer information, and more particularly, to technology for processing electronic documents.

2. Description of the Related Art

When making changes to an electronic document, if an original copy of the existing electronic document cannot be changed, for example, if the electronic document is an Adobe PDF file, tasks such as drawing lines or writing explanations while viewing the electronic document have to be performed manually by printing the electronic document. Alternatively, the original document may be converted into an editable format so that explanations can be written and lines can be drawn in it.

This kind of method has created problems such as inconvenience of having to repeatedly copy the original document, increase in the amount of data that needs to be stored, and the like. In addition, along with gradually increasing demand for e-books, adoption of e-books as learning materials such as textbooks, paper, and the like has gradually accelerated, but in real educational settings, notes, explanations, and the like are taken down on printed paper not e-books.

### SUMMARY

The following description relates to an apparatus and method for processing documents that provide an electronic document which is multi-hierarchically structured, and enable tasks such as attachment of explanatory materials, placing of emphasis, and the like, without damaging an original document, thereby increasing effectiveness of the electronic document.

In one general aspect, there is provided an apparatus for processing an electronic document, including: a storage unit that stores the electronic document including a basic layer having a basic document, and an additional layer having displayable additional information which is associated with the basic document; and a control unit that configures the basic document and the additional information.

In another general aspect, there is provided a method for processing an electronic document, including: verifying a hierarchical structure of an electronic document file; and processing the electronic document file in accordance with the verified hierarchical structure, wherein the processing of the electronic document file includes processing a basic layer to extract a basic document when the basic layer is included in the electronic document file, processing an additional layer to extract additional information when the additional layer is included in the electronic document file, and configuring and providing a screen including the basic document and the additional information.

In still another general aspect, there is provided a method for processing an electronic document, including: accessing a file including a basic layer including a basic document and an additional layer that is configured as a different layer from the basic layer and includes displayable additional information associated with the basic document and position information of the basic document; acquiring the basic document using the position information of the basic document included in the additional layer; extracting the additional information from the additional layer; and configuring and providing a screen including the additional information included in the additional layer and the basic document.

In yet another general aspect, there is provided a method for processing an electronic document, including: accessing a file including a basic layer including a basic document and an additional layer that includes displayable additional information associated with the basic document and is configured as a different layer from the basic layer; extracting and processing the basic document from the basic layer; extracting and processing the additional information from the additional layer; and configuring and providing a screen including the basic document and the additional information.

Other features and aspects will be apparent from the following detailed description, the drawings, and the claims.

### BRIEF DESCRIPTION OF THE DRAWINGS

FIG. 1 is a drawing illustrating a configuration of an electronic document which is multi-hierarchically structured according to an embodiment of the present invention;

FIG. 2 is a drawing illustrating a storage format of an electronic document according to an embodiment of the present invention;

FIG. 3 is a drawing illustrating a storage format of an electronic document according to another embodiment of the present invention;

FIG. 4 is a block diagram illustrating a configuration of an apparatus for processing an electronic document according to an embodiment of the present invention;

FIG. 5 is a drawing illustrating a method for processing an electronic document according to an embodiment of the present invention;

FIG. 6 is a drawing illustrating a screen for providing an electronic document processing result according to an embodiment of the present invention; and

FIG. 7 is a drawing illustrating a screen for providing an electronic document processing result according to another embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness. Hereinafter, preferred embodiments of the present invention will be described in detail with reference to accompanying drawings.

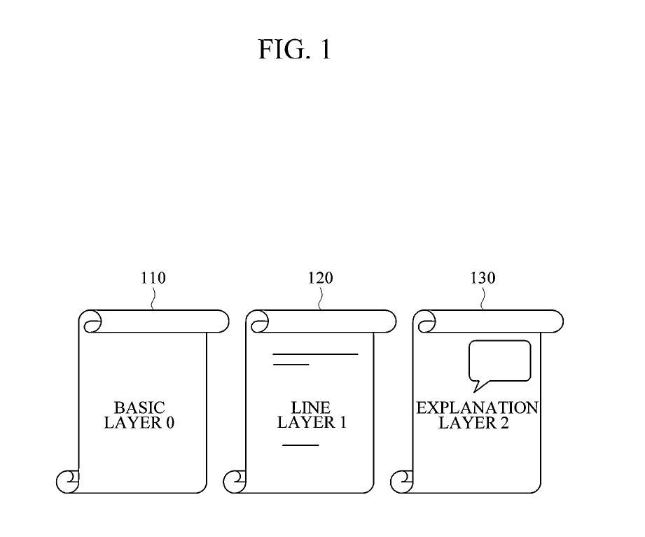

FIG. 1 is a drawing illustrating a configuration of an electronic document which is multi-hierarchically structured according to an embodiment of the present invention.

The electronic document according to an embodiment of the present invention is multi-hierarchically structured. The electronic document may have a variety of formats such as PDF, XML, and the like. The electronic document may include a basic document and additional information for the basic document such as additional lines, explanations, comments, multimedia, and the like. The multimedia may include photos, moving pictures, audio files, formats combining moving pictures and audio files, and the like.

Referring to FIG. 1, the electronic document includes a basic layer 0 (110), a line layer 1 (120), and an explanation layer 2 (130). The basic layer 0 (110) includes a basic document. The line layer 1 (120) and the explanation layer 2 (130) are additional layers associated with the basic document. The line layer 1 (120) includes lines that emphasize a specific portion of the basic document. The explanation layer 2 (130) may include various types of explanations such as text, figures, or the like associated with the specific portion of the basic document. The specific portion of the basic layer may include specific words, phrases, sentences, pictures, or the like in the basic document included in the basic layer.

Multi-hierarchical data including the electronic document may be selectively processed for each layer. For example, only the basic layer 0 (110) may be processed and provided, the basic layer 0 (110) and the line layer 1 (120) may be processed and provided, or the basic layer 0 (110), the line layer 1 (120), and the explanation layer 2 (130) may all be processed and provided.

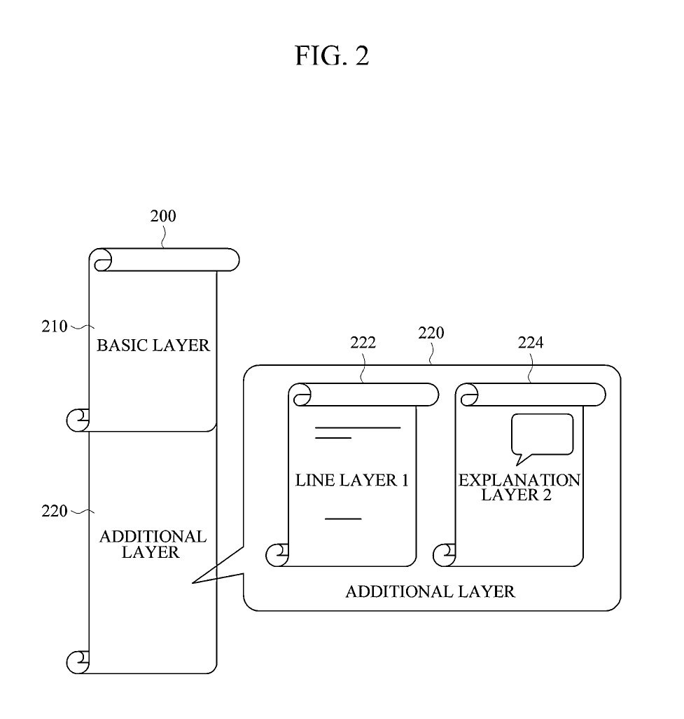

FIG. 2 is a drawing illustrating a storage format of an electronic document according to an embodiment of the present invention.

In FIG. 2, a case in which multi-hierarchical data is configured as a single electronic document file 200 to be stored is illustrated.

The electronic document file 200 which is multi-hierarchically structured may include a basic layer 210 and an additional layer 220 including additional information associated with the basic document. The additional layer 220 may be configured so as not to affect the basic layer 210 including the basic document. As shown in FIG. 2, the additional layer 220 may be positioned at a final portion of the electronic document file 200.

The additional layer 220 may include a plurality of detailed layers 222 and 224 which are mutually distinguished. For example, the additional layer 220 may include a line layer 1 (222) including lines to emphasize specific portions of the basic document, and an explanation layer 2 (224) including explanations in a text format which are associated with the specific portion (for example, words, phases, sentences, pictures, or the like) of the basic document. The explanation layer 2 (224) may include figures in the form of a balloon which include explanations associated with the specific portion of the basic document, but the invention is not limited thereto.

In this manner, when the multi-hierarchical data is stored as a single file, a storage space may not become complex.

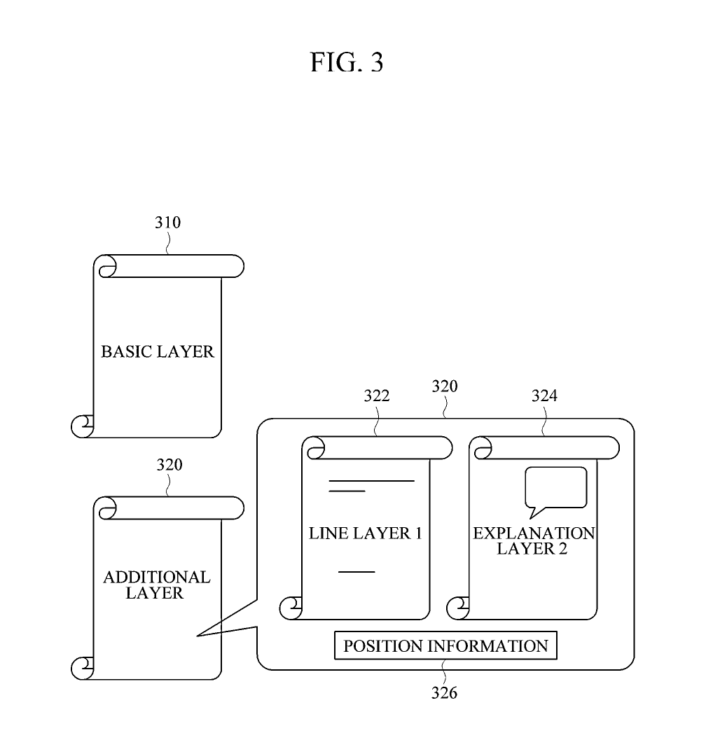

FIG. 3 is a drawing illustrating a storage format of an electronic document according to another embodiment of the present invention.

As shown in FIG. 3, the electronic document which is multi-hierarchically structured may be configured as a different file for each layer. In FIG. 3, each of a basic layer 310 and an additional layer 320 is configured as a separate file. A file of the additional layer 320 may include additional information 322 and 324 associated with a basic document and position information 326 of the basic document.

The additional layer 320 may include a line layer 1 (322) including lines for emphasizing specific portions of the basic document and an explanation layer 2 (324) including explanations in a text format which are associated with the specific portions of the basic document.

The position information 326 may include directory information on a file system of the apparatus for processing the electronic document and a file name thereof, and may be link information indicating a position of the basic document which is positioned on a network. For example, the link information may include uniform resource locator (URL), for example, http://***.***.***/[File name]. When the position information of the basic document is a URL on the network, and a user ID and password are required to acquire basic data, the user ID and password may be further included in the additional layer 320.

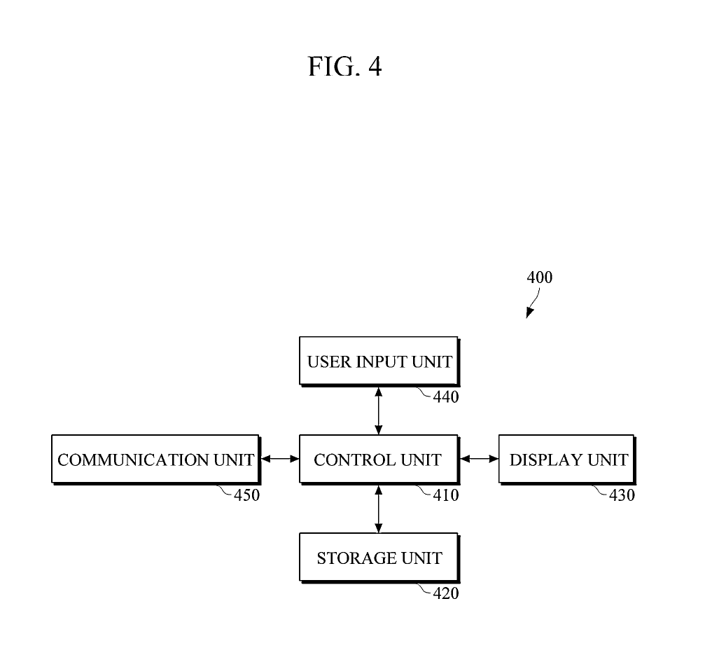

FIG. 4 is a block diagram illustrating a configuration of an apparatus 400 for processing an electronic document according to an embodiment of the present invention.

The apparatus 400 may include a control unit 410, a storage unit 420, a display unit 430, a user input unit 440, and a communication unit 450. The apparatus 400 may be implemented in a terminal device that can process various types of electronic documents, such as a personal computer, an e-book terminal, a smart phone, a laptop computer, and the like.

The control unit 410 drives an operating system and an application of the apparatus 400. The control unit 410 may control operations of the storage unit 420, the display unit 430, the user input unit 440, and the communication unit 450.

The storage unit 420 stores an electronic document according to an embodiment of the present invention. The electronic document may include a basic layer having a basic document and an additional layer having displayable addition information which is associated with the basic document.

The additional layer may include additional information which is configured as a plurality of additional layers. The additional layer may include at least one of a line layer including lines for emphasizing a portion of the basic document, an explanation layer including data for describing the basic document, and a multimedia layer including multimedia associated with the basic document.

The basic layer and the additional layer may be included in a single file. Alternately, each of the basic layer and the additional layer may be configured as a separate file. When each of the basic layer and the additional layer is configured as a separate file, the additional layer may further include a storage position of the basic document. In addition, the additional layer may be distinguished in accordance with a user generating the additional information.

The control unit 410 may process the electronic document according to an embodiment of the present invention, and configure a screen displaying the processed electronic document. The control unit 410 may configure the screen including the basic document and at least one item of the additional information.

The display unit 430 is a display device that displays the screen configured by the control unit 410. The display unit 430 may be an external display device which is connected to the apparatus 400 to be used.

The user input unit 440 is a user interface device that receives a user input signal and may include various types of user input devices such as a keyboard, a touch pad, a touch screen, a mouse, or the like.

When there are at least two additional layers, the user input unit 440 may receive the user input signal for selecting the additional layer to be provided together with the basic document of the basic layer from the at least two additional layers. When the user input signal for selecting the additional layer is received, the control unit 410 may configure a screen including the basic document of the basic layer and the additional information included in the selected additional layer.

The apparatus 400 may configured so as to generate the electronic document which is multi-hierarchically structured. When a user input signal for requesting an input of the additional information about the basic document is received, the control unit 410 may provide a screen for receiving the additional information through the display unit 430. When the additional information is input to the screen configured by the user input unit 440, the input additional information and position information of the basic document may be stored as a different layer from the basic layer to thereby generate the additional layer associated with the basic document.

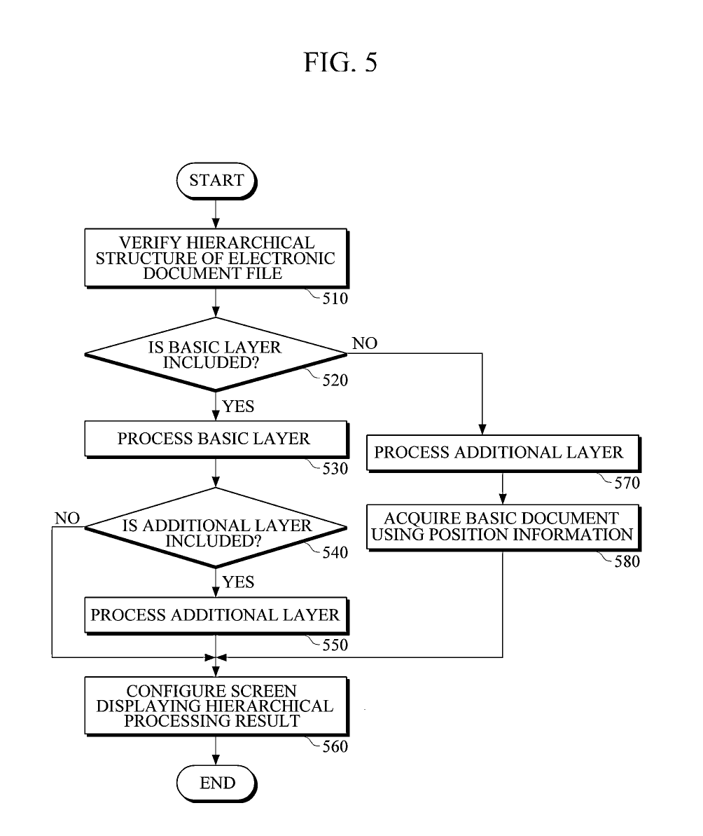

FIG. 5 is a drawing illustrating a method for processing an electronic document according to an embodiment of the present invention.

In operation 510, an apparatus for processing an electronic document according to an embodiment of the present invention accesses an electronic document file to verify a hierarchical structure of the electronic document file. The apparatus may process the electronic document file in accordance with the verified hierarchical structure. Specifically, in operation 520, the apparatus verifies whether a basic layer is included in the accessed electronic document file.

In operation 530, when the basic layer is included in the electronic document file in operation 520, the apparatus processes the basic layer to extract a basic document.

In operation 540, the apparatus verifies whether the additional layer is included in the accessed electronic document file. In operation 550, when the additional layer is included in the accessed electronic document file in operation 540, the apparatus performs a hierarchical processing with respect to all of a plurality of additional layers to thereby extract the additional information included in each of the additional layers. The additional layer may include at least one of a line layer including lines for emphasizing a portion of the basic document, an explanation layer including data for describing the basic document, and a multimedia layer including multimedia associated with the basic document.

In operation 560, the apparatus configures a screen displaying a result of the hierarchical processing. Specifically, in operation 560, when the basic layer and the additional layer are processed, the apparatus configures and provides the screen including the basic document and the additional information.

Meanwhile, in operation 570, when the basic layer is not included in the electronic document file in operation 520, that is, when only the additional layer is included in the corresponding electronic document file, the apparatus performs an additional hierarchical processing to extract the additional information from the additional layer. Position information indicating a position of the basic document of the basic layer is included in the additional layer. In operation 580, the apparatus acquires the basic document using the position information.

Next, in operation 560, the apparatus configures and provides the screen including the basic document and the additional information.

In operation 560, when only the basic layer is included in the electronic document file in operation 520, and the additional layer is not included in the electronic document file, the apparatus configures and provides the screen including the basic document that is a basic layer processing result as the hierarchical processing result.

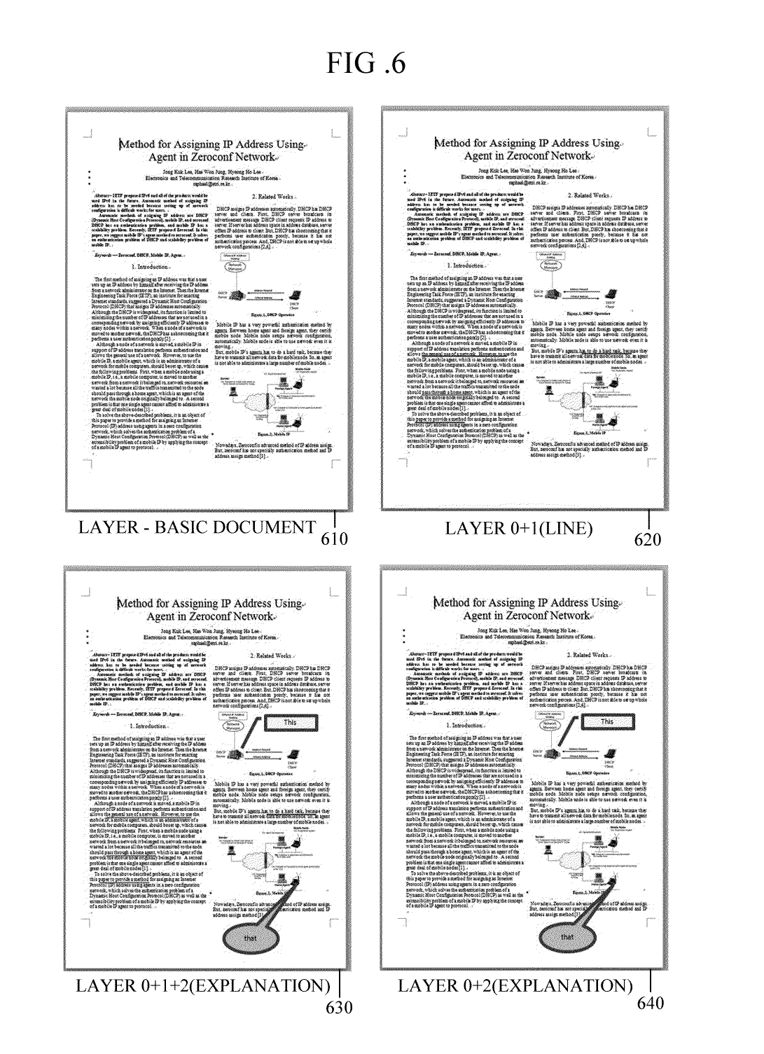

FIG. 6 is a drawing illustrating a screen for providing an electronic document processing result according to an embodiment of the present invention.

A screen 610 indicates a screen in which a basic document of a basic layer 0 is provided. According to an embodiment of the present invention, an apparatus for processing an electronic document may include the basic layer 0 and a line layer 1, and provide a screen 620 in which lines of the line layer 1 are drawn on a basic document of the basic layer 0.

In addition, the apparatus may synthesize the lines of the line layer 1 and explanation information of the explanation layer 2 on the basic document of the basic layer 0 in order to provide a screen including the basic layer 0, the line layer 1, and an explanation layer 2, thereby providing a screen 630 in which the lines and explanation information are added to the basic document.

Alternatively, the apparatus may synthesize the basic document of the basic layer 0 and the explanation information of the explanation layer 2 in order to configure a screen including the basic layer 0 and the explanation layer 2, thereby providing a screen 640 in which the explanation information is added to the basic document. The additional layer including the additional information to be provided together with the basic document of the basic layer 0 may be selected in accordance with a user input signal.

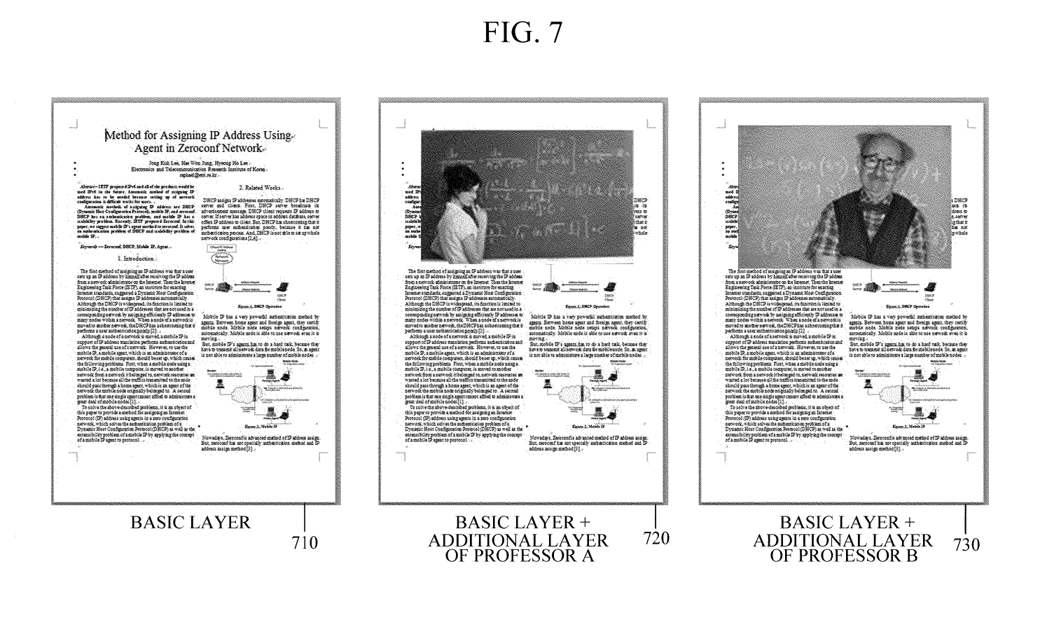

FIG. 7 is a drawing illustrating a screen for providing an electronic document processing result according to another embodiment of the present invention.

An additional layer may be configured for each user generating additional information. For example, the additional layer associated with a basic layer including a single basic document may include an additional layer including multimedia that is generated in association with the basic document by a professor A, and an additional layer including multimedia that is generated in association with the basic document by a professor B.

A screen 710 indicates a screen in which only the basic layer including the basic document is processed.

As shown in the screen 720, a moving picture layer including a moving picture concerning a lecture on the basic document given by the professor A, a line layer for emphasizing a specific portion of the basic document, and an explanation layer including explanations about the basic document are synthesized on the basic layer including the basic document, thereby providing an electronic document in which the moving picture concerning the lecture given by the professor A, the emphasized lines, and the explanations are added.

In addition, as shown on a screen 730, a moving picture layer including a moving picture concerning a lecture on the basic document given by the professor B, a line layer for emphasizing a specific portion of the basic document, and an explanation layer including explanations about the basic document are synthesized on the basic layer including the basic document, thereby providing an electronic document in which the moving picture concerning the lecture given by the professor B, the emphasized lines, and the explanations are added.

The apparatus having the above-described configuration, allows a user to selectively view lectures given by different people and lecture materials with respect to a single basic document, thereby maximizing effects of the lectures.

As described above, according to the embodiments of the present invention, in order to eliminate inconvenience and provide various services, e-books, electronic documents, and the like may be more effectively used by introducing a concept of multi-hierarchy.

In addition, when the prevent invention is used when a document is created, a document desired by a user may be directly created or corrected, such as corrected for typing errors, by copying the document and pasting the copied document to another layer as is. Information required for reading/learning such as emphasis, explanations, and the like which are suitable for e-books/electronic documents without affecting an original document can be easily written in the e-books/electronic documents. In addition, when there are mutually different views on a single theory, the mutually different views are stored in respective layers to be compared, thereby enabling easy comparison.

In addition, by providing both a method of storing an electronic document in an original document and a method of separately storing the electronic document, users can conveniently performing corrections, etc. in e-books/electronic documents without infringing upon copyrights of the e-books/electronic documents. In addition, when an original e-book/electronic document is changed, the change can be immediately applied. For example, when a critical error is present in a portion of a textbook, tens of thousands of students across the country have to re-receive and reinstall the corresponding electronic document, but according to the present invention, when an original document is linked with the corresponding electronic document, only the linked document has to be corrected, so that the students may immediately view the corrected document.

In addition, the present invention can be actively utilized in classes, lectures, and the like using e-book/electronic document, and can greatly contribute to efficient use of storage space. In addition, only link information to an original document need be included, thereby enabling effective application in a mobile environment with only a minimal amount of data.

The present invention can be implemented as computer-readable codes in a computer-readable recording medium. The computer-readable recording medium includes all types of recording media in which computer-readable data are stored. Examples of the computer-readable recording medium include a ROM, a RAM, a CD-ROM, a magnetic tape, a floppy disk, and an optical data storage. Further, the recording medium may be implemented in the form of carrier waves such as employed in Internet transmission. In addition, the computer-readable recording medium may be distributed to computer systems over a network, in which computer-readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for processing an electronic document, comprising:
a storage unit that stores the electronic document including a basic layer having a basic document, and an additional layer having displayable additional information which is associated with the basic document; and
a control unit that configures a screen including the basic document and the additional information.

2. The apparatus according to claim 1, wherein the basic layer and the additional layer are included in a single file.

3. The apparatus according to claim 1, wherein each of the basic layer and the additional layer is configured as a separate file.

4. The apparatus according to claim 3, wherein the additional layer includes a storage position of the basic document.

5. The apparatus according to claim 1, wherein the additional layer includes at least one of a line layer including a line for emphasizing a part of the basic document, an explanation layer including data for describing the basic document, and a multimedia layer including multimedia associated with the basic document.

6. The apparatus according to claim 1, wherein the additional layer is distinguished in accordance with a user generating the additional layer.

7. The apparatus according to claim 1, further comprising:
a user input unit that receives a user input signal for selecting the additional layer to be provided together with the basic layer when there are at least two additional layers,
wherein the control unit configures a screen including the basic layer and the selected additional layer.

8. The apparatus according to claim 1, wherein when a user input signal for requesting input of the additional information about the basic document is received, the control unit configures a screen for receiving the additional information, and when the additional information is input to the configured screen, the control unit stores the input additional information and position information of the basic document in a different layer from the basic layer.

9. A method for processing an electronic document, comprising:
verifying a hierarchical structure of an electronic document file; and
processing the electronic document file in accordance with the verified hierarchical structure,
wherein the processing of the electronic document file includes processing a basic layer to extract a basic document when the basic layer is included in the electronic document file, processing an additional layer to extract additional information when the additional layer is included in the electronic document file, and configuring and providing a screen including the basic document and the additional information.

10. The method according to claim 9, further comprising:
verifying position information of the basic document from the additional layer when the basic layer is not included in the electronic document file, and acquiring the basic document using the verified position information.

11. The method according to claim 9, wherein the additional layer includes at least one of a line layer including a line for emphasizing a part of the basic document, an explanation layer including data for describing the basic document, and a multimedia layer including multimedia associated with the basic document.

12. The method according to claim 9, further comprising:
receiving a user input signal for selecting the additional layer including the additional information to be provided together with the basic document of the basic layer,
wherein the configuring and providing of the screen includes configuring and providing the screen including the basic document of the basic layer and the additional information of the selected additional layer.

13. The method according to claim 9, wherein the position information includes directory information of a file system or link information used for connecting to the basic document existing on a network.

14. The method according to claim 9, wherein the additional layer is distinguished in accordance with a user generating the additional information.

15. A method for processing an electronic document, comprising:
accessing a file including a basic layer including a basic document and an additional layer that is configured as a different layer from the basic layer and includes displayable additional information associated with the basic document and position information of the basic document;
acquiring the basic document using the position information of the basic document included in the additional layer;
extracting the additional information from the additional layer; and
configuring and providing a screen including the additional information included in the additional layer and the basic document.

16. The method according to claim 15, wherein the position information includes directory information of a file system or link information used for connecting to the basic document existing on a network.

17. A method for processing an electronic document, comprising:
accessing a file including a basic layer including a basic document and an additional layer that includes displayable additional information associated with the basic document and is configured as a different layer from the basic layer;
extracting and processing the basic document from the basic layer;
extracting and processing the additional information from the additional layer; and
configuring and providing a screen including the basic document and the additional information.

18. The method according to claim 17, wherein the configuring and providing of the screen includes providing a screen for allowing a user to select a partial additional layer from a plurality of additional layers when the plurality of additional layers are included in the accessed file, and providing a screen including the additional information of the additional layer selected in accordance with a user input signal for selecting the partial additional layer and the basic document of the basic layer.
